(19) United States
(12) Patent Application Publication
(10) Pub. No.: US 2026/0212859 A1
(43) Pub. Date: Jul. 23, 2026

(54) SYNTHESIS OF LING SOUNDS

(71) Applicant: MED-EL Elektromedizinische Geräte GmbH, Innsbruck (AT)

(72) Inventors: Martin Billinger-Finke, Innsbruck (AT); Mathias Kals, Grinzens (AT)

(73) Assignee: MED-EL Elektromedizinische Geräte GmbH, Innsbruck (AT)

(21) Appl. No.: 19/140,314

(22) PCT Filed: Dec. 28, 2023
(86) PCT No.: PCT/US2023/086235

§ 371 Date: Jun. 17, 2025

Related U.S. Application Data
(60) Provisional application No. 63/435,970, filed on Dec. 29, 2022.

(51) Int. Cl. G10L 13/04

(52) U.S. Cl. CPC G10L 13/04

(57) ABSTRACT

The system and method for using a recording of a human reciting a Ling sound to create a synthetic Ling sound for use in a Ling test. First, the recording of the human is decomposed into at least a shape component. Then, a synthetic source is whitened and multiplied with the shape component of the human recording to create a synthetic Ling sound that is customizable and has less fluctuations in pitch.

### CROSS-REFERENCE TO RELATED APPLICATIONS

This application claims priority from U.S. Provisional Patent Application 63/435,970, filed Dec. 29, 2022, which is hereby incorporated herein by reference in its entirety.

### TECHNICAL FIELD

The present invention relates to a system and method for synthesizing a synthetic Ling sound and more particularly to decomposing a frequency spectrum of a human recording of a Ling sound to provide a shape component, and then adding a synthetic source to the shape component to create a synthetic Ling sound.

### BACKGROUND ART

Audiologists use speech tests to assess their patients' ability to understand speech. This makes speech tests a constant companion in the lives of cochlear implant users and other people with hearing difficulties. First, they are used to determine if a hearing-impaired patient is eligible for a cochlear implant. Subsequently, speech tests measure how successful the implantation was, and may even guide the process of fitting and re-fitting the implant.

A particularly interesting speech test is the Ling test, named after Daniel Ling. This test consists of six sounds that were chosen to cover the auditory spectrum relevant for human, originally North American, speech. The typical six Ling sounds in English are: (1) AH, (2) EE, (3) OO, (4) M, (5) S, and (6) SH. In German, the typical six Ling sounds are: (1) A, (2) I, (3) U, (4) M, (5) S, and (6) SCH.

Ling tests can be used during fitting of a cochlear implant. During the fitting, the medical professional sets a lower and upper threshold for the cochlear implant to make sure the patient can hear each sound, and do so without discomfort. Ling tests are an advantageous way to confirm the hearing of a patient, as they break down speech into a mere six sounds.

Ling tests are advantageous over typical speech-based hearing tests for a plurality of reasons. Ling sounds are fast and simple, only consisting of a few short items, while speech tests work with groups of words or sentences. Ling sounds are independent of context, and thus the listener is only measuring what is heard, without external sources educating the guess. The Ling sounds can be used in a variety of languages because they do not convey any meaning. A speaker of any language will be able to parse together the sounds to determine if their hearing is sufficient.

Ling sounds are also specific and informative. Classic speech tests result in summary measures, such as a percentage of understood words. Since the spectral characteristics of each Ling sound are known, the Ling test is able to more narrowly pinpoint hearing deficiencies. Illustratively, a patient who has difficulty hearing the fifth Ling sound may have trouble with high frequencies.

Typically, Ling tests are administered orally by a human proctor, such as an audiologist. The proctor simply speaks one of the sounds and asks the patient if they can hear the sound(s), distinguish the sound from other sounds, and if they can repeat the sound. These questions determine detection, discrimination, and identification respectively.

While the procedure is simple to perform, it has a lot of variation dependent on the proctor. Each proctor may have a different pronunciations, volume, duration of sounds, and interpretive results. Therefore, an alternative approach is to use a recorded sound. Recorded material in the test helps reduce variation, but it brought about new problems in performing a Ling test. The duration of the recorded sounds is dependent on the human recorder's abilities. Further, once the sound is recorded, the same sounds are repeated over and over. Patients may eventually learn to recognize certain sounds from non-speech relevant cues, such as fluctuations in the recorded voice.

Therefore it would be advantageous to develop a synthetically created Ling sound. Synthetic sounds have none of the disadvantages of spoken sounds, as they do not have fluctuations of variations and can be produced in any duration. Furthermore, parameters that determine voice characteristics can be adjusted in real time.

However, synthetic Ling sounds are difficult to create. Popular speech synthesizers that produce realistic speech are not designed to produce the prolonged vowels required for Ling sounds. Older speech synthesizers, such as the Klatt model, can produce prolonged sounds but they sound distinctly unnatural.

### SUMMARY OF THE EMBODIMENTS

In accordance with an embodiment of the invention, a method for producing a hybrid Ling sound signal is provided. The method includes decomposing a frequency spectrum of a Ling sound recording made by a human speaker, to provide a shape component. A synthetic source is provided. The synthetic source is whitened. The whitened synthetic source is combined with the shape component to form the hybrid Ling sound spectrum. The hybrid Ling sound spectrum is converted into the time domain to form the hybrid Ling sound signal.

In accordance with related embodiments of the invention, the method may include adjusting the shape component to zero below a frequency value. Decomposing the recording to provide the shape component may include applying a sliding maximum filter, based on a window size, to a magnitude of the recording's spectrum. The window size may be greater than or equal to a fundamental frequency of the synthetic source.

In accordance with further related embodiments of the invention, providing the raw synthetic source may include providing the raw synthetic source with a chosen fundamental frequency. The raw synthetic source for a voiced sound may include providing a synthetic glottal flow signal. Providing the raw synthetic source for unvoiced sounds may include providing a Gaussian white noise.

In accordance with still further related embodiments of the invention, the method may include recording a human speaker for a plurality of Ling sounds wherein each recording produces a hybrid Ling sound signal of its respective Ling sound. Optionally, each hybrid Ling sound signal may have the same fundamental frequency. The frequency value may be 100 Hz.

In accordance with another embodiment of the invention, a non-transitory storage medium storing instructions that, when executed, establish computer processes or a controller, is provided. The computer processes or the controller: decompose a frequency spectrum of a recording of a human speaker into a source component and a shape component; provide a synthetic source; whiten the synthetic source; combine the whitened synthetic source with the shape component to form a hybrid Ling sound spectrum; and convert the hybrid Ling sound spectrum into the time domain to form the hybrid Ling sound signal.

In accordance with related embodiments of the invention, the computer processes or controller may further include adjusting the shape component to zero below a frequency value. Decomposing the recording to provide the shape component may include applying a sliding maximum filter, based on a window size, to a magnitude of the recording's spectrum. The window size may be greater than or equal to a fundamental frequency of the synthetic source.

In accordance with further related embodiments of the invention, providing the raw synthetic source may include providing the raw synthetic source with a chosen fundamental frequency. Providing the raw synthetic source for a voiced sound may include providing a synthetic glottal flow signal. Providing the raw synthetic source for unvoiced sounds may include providing a Gaussian white noise.

In accordance with further related embodiments of the invention, the computer processes or controller may further include decomposing recordings of a human speaker for a plurality of Ling sounds wherein each recording produces a corresponding hybrid Ling sound signal of its respective Ling sound. Each hybrid Ling sound signal may have the same fundamental frequency, such as, without limitation, 100 Hz.

### BRIEF DESCRIPTION OF THE DRAWINGS

The foregoing features of embodiments will be more readily understood by reference to the following detailed description, taken with reference to the accompanying drawings, in which:

FIG. 1 is a flow chart depicting the process of a hybrid approach to synthesizing a Ling sound, in accordance with an embodiment of the present invention; and

FIG. 2 is a plurality of graphical depictions of sound spectrums and parts of sound spectrums, in accordance with an embodiment of the invention.

### DETAILED DESCRIPTION OF SPECIFIC EMBODIMENTS

In illustrative embodiments, a system and method for creating a synthetic Ling sound is provided. The system and method may, for example, take a recording of a human reciting a Ling sound, decompose the recording into a shape component and add a synthetic source to the shape component to create a synthetic Ling sound that is customizable and has less fluctuations in pitch. The synthetic Ling sound may advantageously be used when fitting cochlear implants or other hearing aids. Details are discussed below.

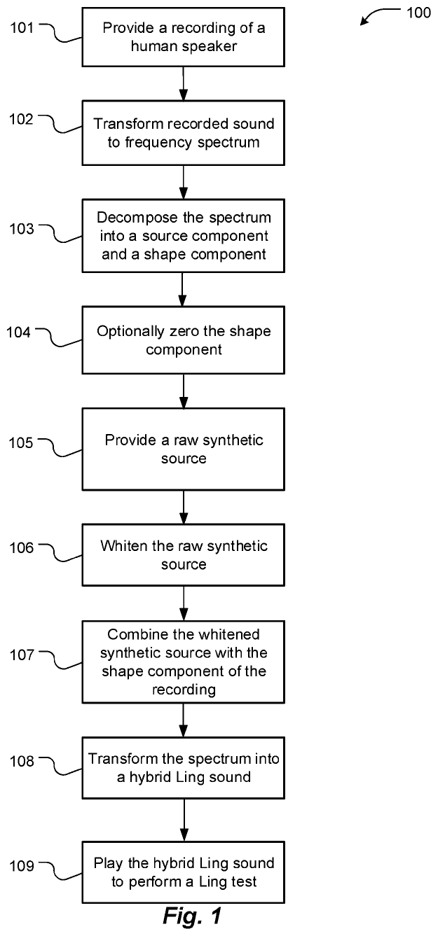

FIG. 1 is a flow chart depicting the process 100 of a hybrid approach to synthesizing a Ling sound, in accordance with one aspect of the present invention. The hybrid approach combines component(s) of a human voice recording with a synthetic source. The hybrid approach advantageously may allow the production of a naturally sounding Ling sound with adjustable pitch, duration, and no predictable fluctuation. In embodiments, various steps of the flow chart may be performed by a computer system or by a controller. The computer system may comprise a non-transitory storage medium which stores instructions to execute processes performing the steps.

The process 100 begins by first providing a recording of a human speaker, step 101. This recording would include the human speaker making one or more Ling sounds.

The recorded sound is then transformed to a spectrum in the frequency domain X(f)=FFT {x(t)}, step 102.

Next, X(f) is decomposed into two parts 103, its source component and its shape component. Decomposition of sounds into two components is often based on the way humans create speech. The vibration and noise created by the larynx is generally the source component. The vocal tract filters the noise from the larynx to form speech sounds and is generally considered the shape component. Since the frequency spectrum of a human speaker often varies over time, the decomposed frequency spectrum may be an average or a spectrum at an instant in time.

The shape component, T(f), may be determined as the spectral envelope of the sound spectrum using the following equation:

$$T ( f ) = {max}_{f ′} \vert X ( {f}^{′} ) \vert , with f - Δ / 2 <= {f}^{′} < f + Δ / 2$$

This equation determines the shape component by taking a sliding maximum filter of X(f). The source component S(f) may be determined from the equation S(f)=X(f)/T(f). Note however, that typically the source component is not needed for the synthesis of a hybrid Ling sound, and may not even be determined in various embodiments.

In various embodiments, the shape component is then zeroed, step 104, before combination with a synthetic source, step 105. Zeroing the shape component helps suppress unwanted low-frequency artifacts which may otherwise be present. These low frequencies are typically not relevant for Ling sound intelligibility. In various embodiments, zeroing the shape component may include setting the T(f) to zero for all values of f below a certain value, for example, 100 Hz. In other embodiments, the zeroing may be done below a certain percentage of the fundamental frequency and/or below a certain percentage of the maximum value of T(f) over all values f, i.e. for a certain value of f the T(f) is smaller than a fraction of max (T(f)) over all values f.

In step 105 a raw synthetic source is provided, which may be obtained or otherwise synthesized from a wide variety of sources such as, for example, various databases or a computer via an algorithm. The fundamental frequency of the raw synthetic source will be indicative of, if not exactly, the fundamental frequency of the final hybrid synthetic Ling sound. As such, the raw synthetic source may advantageously be customized with a desired fundamental frequency. The raw synthetic source may help ensure the sound is stationary in time, i.e., it does not fluctuate in pitch or loudness as human speech naturally does. In various embodiments, the raw synthetic source for unvoiced sounds may be produced from Gaussian white noise, while voiced sounds are produced using a synthetic glottal flow signal. Sample synthetic glottal flow signals can be found in G. Fant, J. Liljencrantz, Q. Lin “A four-parameter model of glottal flow”, STL-QPSR, vol. 26, 1985, which is hereby incorporated herein by reference, in its entirety. In different embodiments, a pulse train may be used for a synthetic source, however, the results may sound more artificial than using a glottal flow.

In step 106, the raw synthetic source is whitened. Whitening the source may include adjusting the volume of each frequency to the same or similar values. In some embodiments, the provided raw synthetic source may already be a whitened signal. Whitening of the synthetic source may provide a constant power spectral density of the raw synthetic source. In various embodiments, the whitened synthetic source may be calculated by dividing the spectrum of the raw synthetic source by a spectral envelope of the raw synthetic source. This would result in uniformity of the peaks in the spectrum of the raw synthetic source, because each peak would be divided by itself. One advantage of whitening the synthetic source is to ensure that each frequency component has a volume in the synthetic source that can be non-diminishingly multiplied by the shape component in step 107.

The whitened raw synthetic source is then combined with the shape component to form the synthetic hybrid Ling sound spectrum, step 107. The combination may be done by multiplying the whitened synthetic source by the shape component. The hybrid Ling sound spectrum may then be transformed back into the time domain, step 108. Step 108 may be accomplished through an inverse fast Fourier transform. Since the synthetic hybrid Ling sound is produced using the raw synthetic source, the synthetic hybrid Ling sound will typically have the same fundamental frequency as the raw synthetic source. Therefore, when producing each of the various Ling sounds a user can advantageously have each Ling sound have the same fundamental frequency. During a Ling test, uniform fundamental frequencies make it more difficult for the tested patient to decipher each Ling sound from another by their pitch.

In step 109, the hybrid Ling sound is played to perform a Ling test. The Ling test may be used during the fitting of a cochlear implant or other hearing device to a particular patient. Illustratively, fitting the cochlear implant ensures that the electrical pulses generated by the cochlear implant in response to a sound wave are done at a low enough level to not hurt the patient, while also high enough to make sure a sound is heard. The pulses are mapped between these two thresholds to allow the patient to appropriately hear the desired range of sounds. Since English, and other languages, are filled with various sounds throughout speech, designing a test that breaks down sounds of speech into 6 sounds provides efficiency in the test. While these sounds are void of context in the form of sentences and words, an audiologist performing the test without the use of hybrid Ling sounds may provide natural tells as to what each sound is. For example, the test giver (or recording) may trail off, speak some sounds at a higher or lower pitch, or have their lips read. A hybrid Ling sound as described herein avoids these tells and provides a more accurate test of the fitting. Furthermore, parameters that determine voice characteristics can be adjusted on the fly, if needed. In various embodiments, an Audiologist may play the hybrid Ling sound and ask the patients a) if they could hear the sound (detection), b) if they can distinguish the sound from others (discrimination), c) or if they can repeat the sound (identification).

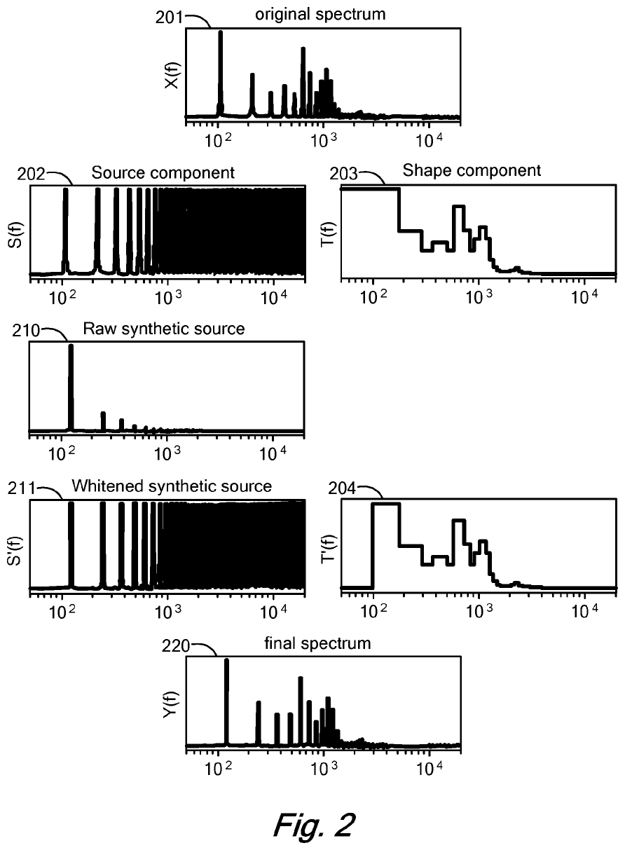

FIG. 2 is a plurality of graphical depictions of sound spectrums and parts of sound spectrums in accordance with one embodiment of the invention. Each graph depicts the sound spectrum in the frequency domain, allowing the creation of a hybrid Ling sound stationary in time. Each graph in FIG. 2 represents a value on the x axis and a frequency on the logarithmic y axis. As described in relation to FIG. 1, the original spectrum 201 may be broken into the source component 202 and the shape component 203. In one embodiment, the original spectrum 201 is a recording of a human voicing the desired Ling sound at a specific instant in time, or an average over a certain period of time.

The source component 202 represents the various frequencies that are present in the original spectrum 201 often having a constant power spectral density. The source component 202 contains the overall pitch of the sound and is responsible for temporal fluctuations. Since the original spectrum 201 is based off of human speech there is a lot of temporal fluctuations, graphically represented as wideness at the base of peaks in original spectrum 201 and source component 202. Further, source component 202 is filled with higher frequencies due to natural tonality causing variations in pitch. Not shown in the graph is how the human speech varies over time, with fluctuations in both frequency and tonality. Therefore, it is desired to provide a synthetic source and discard the original source.

The raw synthetic source 210 is provided as the source component of the synthetic Ling sound. The synthetic source 210 has a customizable fundamental frequency, although in some embodiments the fundamental frequency is determined from the original source component. For different sounds various synthetic sources may be used. In some embodiments, unvoiced sounds such as S and SH are made from a Gaussian white noise synthetic source while voiced sounds such as AH, EE, OO, and M are created using a synthetic glottal flow signal. Further, in some embodiments, it is advantageous to whiten the raw synthetic source to create a constant spectral power density allowing non-diminishing multiplication of the source by the shape component. Whitened synthetic source 211 is derived from the synthetic source 210. In one embodiment, the whitened synthetic source 211 is derived by taking a sliding maximum filter to the magnitude of the raw synthetic source spectrum (similar to the process described for obtaining the shape component), with a A equal to the fundamental frequency to get the spectral envelope. The whitened synthetic source is then divided by its own spectral envelope, essentially causing each peak to be divided by itself.

The shape component 203 represents the envelope of the source frequencies in the spectrum. In various embodiments, the shape component 203 may be determined by taking the maximum value of X(f) over a certain period of time. For each frequency, the value of the shape component is the maximum of the original spectrum between two values. Typically, the two values are represented as f−Δ/2 and f+Δ/2. In various embodiments for voiced sounds (i.e., AH, EE, OO, M), the Δ must be at least the fundamental frequency or greater. In various embodiments for unvoiced sounds (i.e., S, SH), Δ is arbitrary, with lower Δ values providing higher quality results. In some embodiments, Δ is chosen individually for each Ling sound, but for consistency Δ may be the same for each Ling sound. Illustratively, the fundamental frequency may be measured in the original spectrum for all voiced sounds, whereupon the highest fundamental frequency may be chosen and rounded up to get Δ.

In various embodiments, the shape component 203 undergoes a zeroing process and one obtains zeroed shape component 204. Zeroing the shape component helps suppress unwanted low-frequency artifacts as low frequencies are not relevant for Ling sound intelligibility. In the embodiment shown in FIG. 2, the shape component 204 is set to 0 for all frequencies below 100 Hz. In various embodiments, the zeroing may occur up to various frequencies.

The final spectrum 220 is the combination of the whitened synthetic source 211 and the zeroed shape component 204. In some embodiments, the whitened synthetic source spectrum 211 is, without limitation, multiplied by the shape component 204 to obtain the final spectrum 220. The final spectrum 220 is similar to the original spectrum 201 as the graphical representations are of the same Ling sound. Nonetheless, the final spectrum 220 has a plurality of advantageous differences. For example, the fundamental frequency, shown in final spectrum 220 as the first peak, is customizable. Since the source is synthetic it is more easily and accurately changed, for example, on a computer, than it would be for a human to change their voice. The final spectrum 220 also has less tonal variations, as can be seen by the cleaner bases of the peaks and is unchanged in time. This may prevent a listener from being able to judge which Ling sound was heard based on auditory cues.

In some embodiments, to play the sound, the final spectrum 220 will be transformed back into the time domain. To convert the final spectrum 220 to the time domain an inverse fast Fourier transform may be performed on the spectrum.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Embodiments can be implemented in whole or in part as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

The embodiments of the invention described above are intended to be merely exemplary; numerous variations and modifications will be apparent to those skilled in the art. All such variations and modifications are intended to be within the scope of the present invention as defined in any appended claims.

1. A method for producing a hybrid Ling sound signal, the method comprising:
decomposing a frequency spectrum of a recording of a Ling sound made by a human speaker, to provide a shape component;
providing a synthetic source;
whitening the synthetic source;
combining the whitened synthetic source with the shape component to form the hybrid Ling sound spectrum; and
converting the hybrid Ling sound spectrum into the time domain to form the hybrid Ling sound signal.

2. The method of claim 1, further comprising adjusting the shape component to zero below a frequency value.

3. The method of claim 1, wherein decomposing the recording to provide the shape component comprises applying a sliding maximum filter, based on a window size, to a magnitude of the recording's spectrum, and wherein the window size is greater than or equal to a fundamental frequency of the synthetic source.

4. (canceled)

5. The method of claim 1, wherein providing the raw synthetic source comprises providing the raw synthetic source with a chosen fundamental frequency; and
wherein providing the raw synthetic source for a voiced sound comprises providing a synthetic glottal flow signal and/or wherein providing the raw synthetic source for unvoiced sounds comprises providing a Gaussian white noise.

6. (canceled)

7. (canceled)

8. The method of claim 1, further comprising obtaining recordings of a human speaker for a plurality of Ling sounds, wherein decomposing each recording produces a hybrid Ling sound signal of its respective Ling sound.

9. The method of claim 8, wherein each hybrid Ling sound signal has the same fundamental frequency.

10. (canceled)

11. A non-transitory storage medium storing instructions that, when executed, establish computer processes, the computer processes comprising:
decomposing a frequency spectrum of a recording of a human speaker into a source component and a shape component;
providing a synthetic source;
whitening the synthetic source;
combining the whitened synthetic source with the shape component to form a hybrid Ling sound spectrum; and
converting the hybrid Ling sound spectrum into the time domain to form the hybrid Ling sound signal.

12. The non-transitory storage medium of claim 11, wherein the computer processes further comprise adjusting the shape component to zero below a frequency value.

13. The non-transitory storage medium of claim 11, wherein decomposing the recording to provide the shape component comprises applying a sliding maximum filter, based on a window size, to a magnitude of the recording's spectrum, and wherein the window size is greater than or equal to a fundamental frequency of the synthetic source.

14. (canceled)

15. The non-transitory storage medium of claim 11, wherein providing the raw synthetic source comprises providing the raw synthetic source with a chosen fundamental frequency; and
wherein providing the raw synthetic source for a voiced sound comprises: providing a synthetic glottal flow signal and/or providing the raw synthetic source for unvoiced sounds comprises providing a Gaussian white noise.

16. (canceled)

17. (canceled)

18. The non-transitory storage medium of claim 11, wherein the computer processes further comprise obtaining recordings of a human speaker for a plurality of Ling sounds wherein decomposing each recording produces a corresponding hybrid Ling sound signal of its respective Ling sound.

19. The non-transitory storage medium of claim 18, wherein each hybrid Ling sound signal has the same fundamental frequency.

20. (canceled)

21. A system for producing a hybrid Ling sound the system comprising:
a controller configured to:
decompose a frequency spectrum of a recording of a human speaker into a source component and a shape component;
provide a synthetic source;
whiten the synthetic source;
combine the whitened synthetic source with the shape component to form a hybrid Ling sound spectrum; and
converting the hybrid Ling sound spectrum into the time domain to form the hybrid Ling sound signal.

22. The system of claim 21, wherein the controller is further configured to adjust the shape component to zero below a frequency value.

23. The system of claim 21, wherein decomposing the recording to provide the shape component comprises applying a sliding maximum filter, based on a window size, to a magnitude of the recording's spectrum, and wherein the window size is greater than or equal to a fundamental frequency of the synthetic source.

24. (canceled)

25. The system of claim 21, wherein providing the raw synthetic source comprises providing the raw synthetic source with a chosen fundamental frequency; and
wherein providing the raw synthetic source for a voiced sound comprises providing a synthetic glottal flow signal; and/or wherein providing the raw synthetic source for unvoiced sounds comprises providing a Gaussian white noise.

26. (canceled)

27. (canceled)

28. The system of claim 21, wherein the controller is further configured to obtain recordings of a human speaker for a plurality of Ling sounds wherein decomposing each recording produces a hybrid Ling sound signal of its respective Ling sound.

29. The system of claim 28, wherein each hybrid Ling sound signal has the same fundamental frequency.

30. (canceled)

31. A system of fitting a cochlear implant to a human subject that outputs the hybrid sound signal of claim 21 wherein the controller is further configured to output the hybrid sound signal to perform a Ling test.

32. A method of fitting a cochlear implant via a Ling test using the hybrid Ling sound signal of claim 1, the method comprising outputting the hybrid Ling sound to administer a Ling test.

33. (canceled)
